(19) United States
(12) Patent Application Publication
(10) Pub. No.: US 2026/0171083 A1
(43) Pub. Date: Jun. 18, 2026

(54) SPEECH RECOGNITION SYSTEM AND METHOD USING A HYBRID SPEECH RECOGNITION ENGINE

(71) Applicants: HYUNDAI MOTOR COMPANY, Seoul (KR); KIA CORPORATION, Seoul (KR)

(72) Inventor: Bo Hyun Kim, Hwaseong-si (KR)

(73) Assignees: HYUNDAI MOTOR COMPANY, Seoul (KR); KIA CORPORATION, Seoul (KR)

(21) Appl. No.: 19/277,267

(22) Filed: Jul. 22, 2025

(30) Foreign Application Priority Data
Dec. 16, 2024 (KR) 10-2024-0187214

(51) Int. Cl. G10L 15/183; G10L 15/18; G10L 15/26

(52) U.S. Cl. CPC G10L 15/183; G10L 15/1815; G10L 15/26

(57) ABSTRACT

A method performed by a speech recognition system using a hybrid speech recognition engine includes converting, by a cloud automatic speech recognition (ASR) engine, a first speech signal into a first text. The method further includes extracting, by a natural language understanding (NLU) engine, an intent and a slot from the first text. The method further includes learning, by a local ASR engine, a local database. The method further includes converting, by the local ASR engine, a second speech signal corresponding to the slot in the first speech signal into a second text based on a failure of the NLU engine to extract the slot from the first text. The method further includes assigning, by a control module, the second text to the slot.

### CROSS-REFERENCE TO RELATED APPLICATION

This application claims the benefit of and priority to Korean Patent Application No. 10-2024-0187214, filed on Dec. 16, 2024, in the Korea Intellectual Property Office, the entire contents of which are incorporated herein by reference.

### TECHNICAL FIELD

The present disclosure relates to a speech recognition system and a speech recognition method using a hybrid speech recognition engine.

### BACKGROUND

The statements in this section merely provide background information related to the present disclosure and do not necessarily constitute prior art.

A speech recognition system is technology that converts a speech signal of a user into text and executes instructions based on the converted text. Speech recognition technology is becoming more sophisticated with the development of artificial intelligence and deep learning algorithms and is being utilized in various industrial fields.

In particular, an in-vehicle speech recognition system is attracting attention as a key technology for increasing convenience while maintaining driver safety. Drivers can use a speech recognition system to perform various functions, such as setting a navigation route, playing music, and making phone calls. Thus, the burden of visual and tactile input on the driver may be reduced while driving.

An automatic speech recognition (ASR) engine converts an input speech signal into text. The ASR engine analyzes a speech signal based on an acoustic model and a language model and converts the speech signal into text suitable for a specific task. The ASR engine, which operates in a cloud environment, learns a large amount of data set to provide high accuracy. However, the cloud-based ASR engine has the limitation that it is difficult to learn a special database in a local environment.

### SUMMARY

An aspect of the present disclosure is to provide a speech recognition system and a speech recognition system method using a hybrid speech recognition engine. Embodiments of the present disclosure more accurately recognize the meaning of a slot using a local ASR engine that has learned a local database.

The technical objects of the present disclosure are not limited to those described above, and other technical objects not mentioned above may be understood clearly by those having ordinary skill in the art from the descriptions given below.

An embodiment of the present disclosure provides a method performed by a speech recognition system using a hybrid speech recognition engine. The method includes converting, by a cloud automatic speech recognition (ASR) engine, a first speech signal into a first text. The method further includes extracting, by a natural language understanding (NLU) engine, an intent and a slot from the first text. The method further includes learning, by a local ASR engine, a local database. The method further includes converting, by the local ASR engine, a second speech signal corresponding to the slot in the first speech signal into a second text based on a failure of the NLU engine to extract the slot from the first text. The method further includes assigning, by a control module, the second text to the slot.

Another embodiment of the present disclosure provides a speech recognition system using a hybrid speech recognition engine. The speech recognition system includes a cloud ASR engine configured to convert a first speech signal into a first text. The speech recognition system further includes a natural language understanding (NLU) engine configured to extract an intent and a slot from the first text. The speech recognition system further includes a local ASR engine configured to learn a local database and convert a second speech signal corresponding to the slot in the first speech signal into a second text based on a failure of the NLU engine to extract the slot from the first text. The speech recognition system further includes a control module configured to assign the second text to the slot.

According to an embodiment of the present disclosure, it is possible to improve the accuracy of final speech recognition results by accurately extracting the meaning of a slot by utilizing a cloud ASR engine, an NLU engine, and a local ASR engine that has learned a local database together.

The technical effects of the present disclosure are not limited to the technical effects described above, and other technical effects not mentioned herein may be understood to those having ordinary skill in the art to which the present disclosure belongs from the description below.

### BRIEF DESCRIPTION OF THE DRAWINGS

FIG. 1 is a block diagram of a speech recognition system according to an embodiment of the present disclosure.

FIG. 2 is a diagram illustrating data stored in a local database according to an embodiment of the present disclosure.

FIG. 3 is a flowchart schematically illustrating a speech recognition process according to an embodiment of the present disclosure.

FIG. 4 is a diagram schematically illustrating a configuration of a computing device that can be used to implement devices and methods described in the present disclosure.

### DETAILED DESCRIPTION

Hereinafter, some embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein has been omitted for the purpose of clarity and for brevity.

Additionally, various terms, such as first, second, A, B, (a), (b), etc., are used solely to differentiate one component from the other terms and are not intended to imply or suggest the substances, order, or sequence of the components. Throughout the present disclosure, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe embodiments of the present disclosure and is not intended to represent the only embodiments in which the present disclosure may be practiced. When a controller, apparatus, module, component, device, element, or the like of the present disclosure is described as having a purpose or performing an operation, function, or the like, the controller, apparatus, module, component, device, element, or the like should be considered herein as being “configured to” meet that purpose or to perform that operation or function. Each controller, apparatus, module, component, device, element, and the like may separately embody or be included with a processor and a memory, such as a non-transitory computer readable media, as part of the apparatus.

A natural language understanding (NLU) engine analyzes a speech signal converted into text by the ASR engine to extract the intent of a user and slot information. For example, if the ASR engine converts a speech signal “Set an alarm for 3 PM tomorrow” into text “Set an alarm for 3 PM tomorrow”, the NLU engine extracts “Set an alarm” as an intent and “3 PM tomorrow” as time information based on the converted text. A cloud based automatic speech recognition (ASR) engine and the NLU engine learn a large database and provide high accuracy in general speech recognition, but have limitations with respect to data from local devices. In particular, although various types of content are being added to in-vehicle systems, it is realistically impossible for a cloud ASR engine to learn all content with respect to the vehicle.

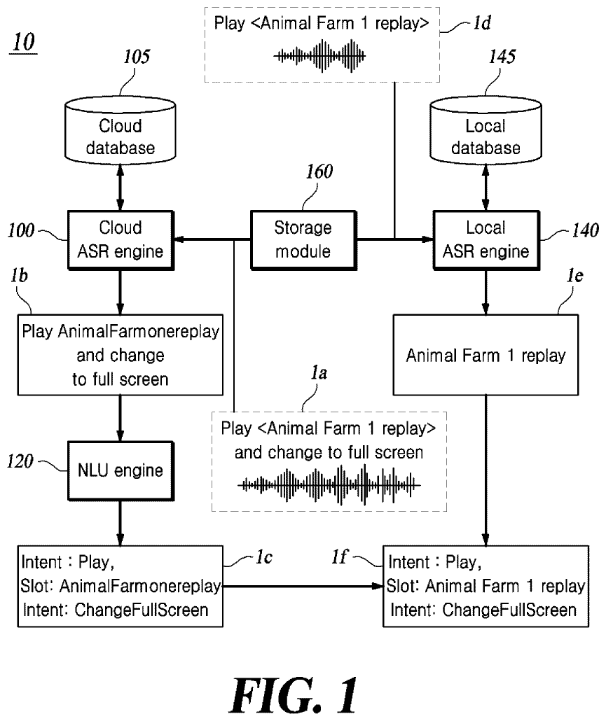

FIG. 1 is a block diagram of a speech recognition system 10 according to an embodiment of the present disclosure.

The speech recognition system 10 of the present disclosure is a system that extracts an intent and a slot from a human speech signal and provides an action or a service corresponding to the extracted intent and slot by utilizing a cloud automatic speech recognition (ASR) engine operating in a cloud environment, a natural language understanding (NLU) engine, and a local ASR engine operating in a local environment together.

Referring to FIG. 1, the speech recognition system 10 according to an embodiment of the present disclosure may include a cloud ASR engine 100, a cloud database 105, an NLU engine 120, a local ASR engine 140, a local database 145, a storage module 160, and a control module. The components illustrated in FIG. 1 represent functionally distinguished elements, and one or more components may be integrated into an actual physical environment. It should be readily understood by those having ordinary skill in the art that mutual positions of components can be changed in response to the performance or structure of the system. For example, the speech recognition system 10 may be installed in an external server or a user device. Some of the components may be installed in an external server, and others may be installed in a user device. The user device may be a mobile device, such as a smartphone, a tablet, a wearable device, a home appliance equipped with a user interface, or a vehicle.

The cloud ASR engine 100 and the local ASR engine 140 may refer to speech-to-text (STT) engines and may convert a speech signal representing a user's speech into text by applying a speech recognition algorithm or a neural network model to the speech signal.

A speech signal is a physical representation of sound and refers to a raw speech signal input to a microphone. For example, a speech signal may be input to an input device, such as a microphone.

Speech data is a comprehensive representation of features extracted from a speech signal or digital data and may be utilized in artificial intelligence (AI) model training, speech recognition, text conversion, etc. For example, features extracted from a digital speech signal are converted into text by the ASR engine.

The cloud ASR engine 100 and the local ASR engine 140 may extract a feature vector by applying a feature vector extraction technique, such as Cepstrum, Linear Predictive Coefficient (LPC), Mel Frequency Cepstral Coefficient (MFCC), or Filter Bank Energy to a speech signal. The cloud ASR engine 100 and the local ASR engine 140 may obtain a speech recognition result by comparing the extracted feature vector with a trained reference pattern. The cloud ASR engine 100 and the local ASR engine 140 may use an acoustic model that analyzes a feature vector to calculate a phoneme probability and/or a language model that generates text by composing sentences based on phoneme probability.

The cloud ASR engine 100 may convert a speech signal into text by learning the large database 105 in a cloud environment. For example, the cloud ASR engine that has learned a large amount of language and speech signals can have higher recognition performance for general-purpose speech signals than the local ASR engine. For example, the cloud ASR engine 100 may have a high recognition rate for free speech, but there may be a delay in converting a speech signal into text based on the server situation.

The local ASR engine 140 operates in a local device or a local environment. The local ASR engine 140 may convert a speech signal into text optimized for a specific environment by learning the local database 145. Although a vehicle provides various types of content (e.g., Melon, Genie, Millie's Library, etc.), it takes a lot of time and money to learn databases of all content in a cloud server. Therefore, the local ASR engine of the speech recognition system 10 of the present disclosure can improve the accuracy of speech recognition by cooperating with the cloud ASR engine. For example, the local ASR engine 140 may exhibit a high recognition rate only for specific fixed phrases in a vehicle and may have a higher speed of processing of converting a speech signal into text than the cloud ASR engine. The engines 100, 120, and 140 of the present disclosure may be implemented as one or more software modules or components installed on one or more computing devices at one or more locations. As an example, one or more computing devices may be dedicated to a specific engine. As another example, multiple engines may be executed on the same computing device (or computing devices).

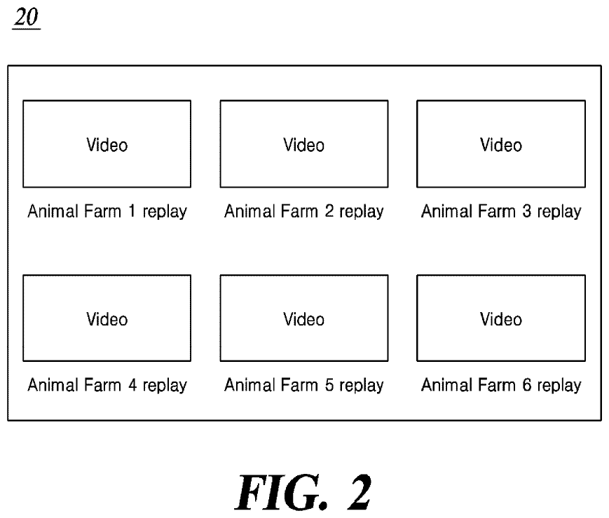

FIG. 2 is a diagram illustrating data stored in the local database according to an embodiment of the present disclosure.

The local database 145 of the present disclosure is configured to store a data set configured such that the local ASR engine 140 can learn and operate according to a local environment or user demand. Unlike a cloud database, the local database 145 includes unique data of individual devices or terminals, and thus it can be said to be a data set for information optimized for a local environment.

The local database 145 may digitize text information of a display 20 in a vehicle using optical character recognition (OCR) technology. Referring to FIG. 2, the local database 145 may store the titles of video content provided by the display 20 of the vehicle, such as <Animal Farm 1> to <Animal Farm 6>, as text data. Here, the display 20 may display multimedia content that can be played in the vehicle, the operating status of the vehicle, a menu for setting navigation or similar functions, etc.

The local database 145 may digitize accumulated data based on a usage pattern of the user. For example, if a place, for example My Place 1, that the user frequently visits and a contact name, for example Girlfriend, are present, the local ASR engine 140 can recognize “Move to my place 1” and “Call my girlfriend”.

The local database 145 may digitize information on various types of content provided by the vehicle. For example, the information may include air conditioning temperature, audio channels, and titles and options available for an entertainment system.

The NLU engine 120 extracts at least one of a user's intent or a slot included in text converted from a speech signal. For example, the NLU engine 120 may extract information such as a domain, a slot, and a speech act from the text and may recognize the intent and the slot according to the intent based on the extraction result. A slot may be referred to as an entity.

The NLU engine 120 segments an input sentence into morphemes, projects the morphemes into a vector space, groups the projected vectors to classify the intent according to the input sentence, and extracts word components according to the intent in the input sentence as slots.

The term “speech recognition result” used in the present disclosure means “text” converted from a speech signal acquired by the cloud ASR engine 100 and the local ASR engine 140. The term “NLU result” used in the present disclosure means an intent and/or a slot acquired by the NLU engine 120. The term “final speech recognition result” used in the present disclosure means a result obtained by combining “speech recognition result” and “NLU result” obtained from the ASR engine and the NLU engine.

Table 1 shows utterances for explaining the operations of the cloud ASR engine 100, the NLU engine 120, and the local ASR engine 140 when an utterance is input to the speech recognition system 10 according to an embodiment of the present disclosure.

TABLE 1

| | |
|---|---|
| Utterance 1 | Open the window and open the sunroof |
| Utterance 2 | Play <Animal Farm 1 replay> and change to full screen |
| Utterance 3 | Play <Animal Farm 1 replay> and push Like button |
| | for <Animal Farm 1 replay> |

In the case of utterance 1, when the speech signal is input to the cloud ASR engine 100, the speech signal is converted into text “Open the window and open the sunroof”. When the converted text “Open the window and open the sunroof” is input to the NLU engine 120, an NLU result such as “Intent: OpenWindow/Intent: OpenSunroof” can be obtained.

The case of utterance 2 is described with reference to FIG. 1. When the speech signal “Play <Animal Farm 1 replay> and switch to full screen” 1a is input to the cloud ASR engine 100, the speech signal is converted into text “Play AnimalFarmonereplay and change to full screen” 1b. When the converted text “Play AnimalFarmonereplay and change to full screen” 1b is input to the NLU engine 120, if data for the slot value of the converted text is stored in the cloud database 105, normalized values can be loaded. However, if the data for the slot value of the converted text is not stored in the cloud database 105 and thus slot extraction fails, an NLU result such as “Intent: Play, slot: AnimalFarmonereplay/Intent: ChangeFullScreen” 1c can be obtained.

Meanwhile, because “AnimalFarmonereplay” is an out-of-vocabulary (OOV) or an unknown word, the vehicle control module cannot recognize “AnimalFarmonereplay”. When the control module fails to extract the slot, if only the speech signal “Play <Animal Farm 1 replay>” 1d corresponding to the slot that failed to be extracted is input to the local ASR engine 140, the speech signal is converted into “Animal Farm 1 Replay” 1e. As a result, by assigning the intent extracted by the NLU engine 120 and the text converted by the local ASR engine 140 to the slot, the NLU result and the speech recognition result can be collated. Accordingly, the final speech recognition result, “Intent: Play, slot: Animal Farm 1 replay/Intent: ChangeFullScreen” if, can be obtained.

In the case of utterance 3, when the speech signal is input to the cloud ASR engine 100, the speech signal is converted into text “Play AnimalFarmonereplay and push Like button for AnimalFarmonereplay”. When the converted text “Play AnimalFarmonereplay and push Like button for AnimalFarmonereplay” is input to the NLU engine 120, if data for the slot value of the converted text is stored in the cloud server, normalized values can be loaded. However, if the data for the slot value of the converted text is not stored in the server and thus slot extraction fails, an NLU result such as “Intent: Play, slot: AnimalFarmonereplay/Intent: PushLikeButton, slot: AnimalFarmonereplay” can be obtained. However, because “AnimalFarmonereplay” is an out-of-Vocabulary (OOV) or an unknown word, the vehicle control module cannot recognize “AnimalFarmonereplay”. In this case, if the entire speech signal is input to the local ASR engine 140, it is converted into text “Animal Farm 1 replay”. As a result, by assigning the intent extracted by the NLU engine 120 and the text converted by the local ASR engine 140 to the slot, the final speech recognition result “Intent: Play, slot: Animal Farm 1 replay/Intent: PushLikeButton, slot: Animal Farm 1 replay” can be obtained.

The storage module 160 of the present disclosure may include a buffer. The buffer may temporarily store speech signals and may operate as a memory component that coordinates a data flow between the cloud ASR engine 100 and the local ASR engine 140.

The present disclosure may further include a dialogue manager manages dialogues between the speech recognition system 10 and a user. For example, the dialogue manager may determine a corresponding action based on an intent and a slot of an utterance, which are a result of speech recognition by the speech recognition system 10 of the present disclosure.

The present disclosure may further include a result processing module. For example, the result processing module may provide services such as generating a dialogue response and instructions required for an action based on the action transmitted from the dialogue manager. The result processing module may visually or audibly output a dialogue response such as text, an image, or audio. As another example, when instructions are output from the result processing module, providing services, such as vehicle control, and providing external content corresponding to the output instructions may be performed. For example, when the final speech recognition result according to an embodiment of the present disclosure is “Intent: Play, slot: Animal Farm 1 replay/Intent: ChangeFullScreen”, the dialogue manager may determine to play <Animal Farm 1> in full screen on the vehicle display, and the result processing module may play <Animal Farm 1> in full screen on the vehicle display.

The present disclosure may further include a preprocessing module. The preprocessing module may remove noise from a speech input from a user. Noise removal is a process of removing background noise or unnecessary signals from a speech signal to improve the quality of the speech signal. For example, a signal-to-noise ratio (SNR) is improved by using spectral subtraction, a Wiener filter, or a deep learning-based noise removal model. As a result, the cloud ASR engine 100 and the local ASR engine 140 can process speech data more accurately.

The present disclosure may further include a control module. The control module may control the operations of components in the speech recognition system 10. For example, the control module may assign text converted from a speech signal by the local ASR engine to a slot extracted from the speech signal by the cloud NLU engine.

Meanwhile, the dialogue manager, the result processing module, the preprocessing module, and the control module refer to software-based components designed to perform the aforementioned operations within the speech recognition system 10. The modules of the present disclosure may be implemented as a memory storing data regarding an algorithm for performing the aforementioned operations or a program reproducing the algorithm and may be implemented as a processor performing the aforementioned operations using the data stored in the memory. As an example, the respective modules may be individually executed on one or more computing devices. As another example, multiple modules may be executed in parallel on the same computing device.

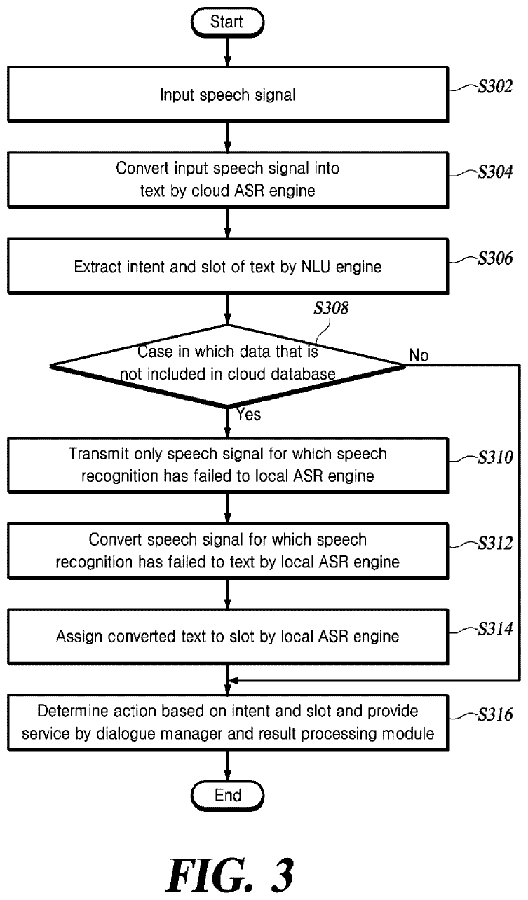

FIG. 3 is a flowchart schematically illustrating a speech recognition process according to an embodiment of the present disclosure.

The speech recognition system 10 receives a speech signal using an input device, such as a microphone. The input speech signal is stored in the storage module 160 and may be used in other components such as the cloud ASR engine 100 and the local ASR engine 140 (in an operation S302).

The cloud ASR engine 100 converts the input speech signal into text. For example, if the user's utterance, e.g., “Play <Animal Farm 1 replay> and change to full screen” 1a, is input as a speech signal, the cloud ASR engine 100 converts the speech signal into text, “Play AnimalFarmonereplay and change to full screen” 1b (in an operation S304).

The NLU engine 120 receives the converted text 1b from the cloud ASR engine 100. The NLU engine 120 analyzes the converted text 1b to extract the user's intent and slot. For example, the NLU engine 120 may obtain an NLU result, such as “Intent: Play, slot: AnimalFarmonereplay/Intent: ChangeFullScreen” 1c, from the converted text 1b (in an operation S306).

If data regarding the slot value of the converted text is stored in the cloud database 105 for the slot of the result 1c obtained from the NLU engine 120, normalized values can be loaded, and thus the process proceeds to the next step (in an operation S308).

If the data regarding the slot value of the converted text is not stored in the cloud database 105, i.e., if “AnimalFarmonereplay” is an OOV or an unknown word and thus slot extraction fails (YES in S308), the storage module 160 transmits only the portion of the entire speech signal, “Play <Animal Farm 1 replay>” 1d, which is a speech signal for which speech recognition has failed, to the local ASR (in an operation S310).

The local ASR engine 140 converts the received speech signal, “Play <Animal Farm 1 replay>” 1d, into text “Animal Farm 1 replay” 1e based on learning of the local database 145 (in an operation S312).

The control module can obtain the final speech recognition result by assigning the text “Animal Farm 1 replay” 1e, which is the text converted by the local ASR engine 140, to the slot extracted by the NLU engine and combining the same (in an operation S314).

The dialogue manager may determine a corresponding action based on the collected intent and slot. In addition, the result processing module may provide a service corresponding to the action based on the action determined by the dialogue manager. For example, if the final speech recognition result is “Intent: Play, slot: Animal Farm 1 replay/Intent: ChangeFullScreen”, the dialogue manager may determine to play <Animal Farm 1> in full screen on the vehicle display, and the result processing module may play <Animal Farm 1> in full screen on the vehicle display (in an operation S316).

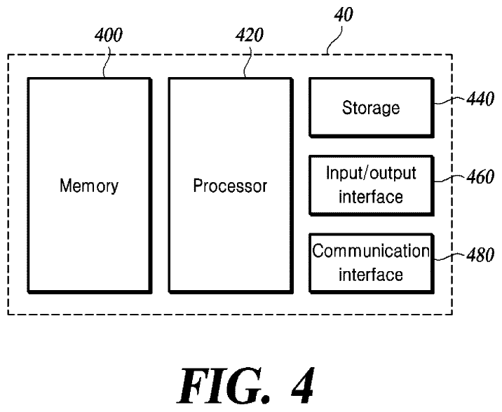

FIG. 4 is a diagram schematically illustrating a configuration of a computing device that may be used to implement the devices and methods described in the present disclosure.

The computing device 40 may include all or part of a memory 400, a processor 420, a storage 440, an input/output interface 460, and a communication interface 480. The computing device 40 may be a stationary computing device, such as a desktop computer or a server, or a mobile computing device, such as a laptop computer or a smart phone. The computing device 40 may include a specialized hardware accelerator capable of processing operations of an artificial intelligence model in an efficient manner. For example, the computing device 40 may include a graphic processing unit (GPU), a tensor processing unit (TPU), or a neural processing unit (NPU).

The memory 400 may store a program that enables the processor 420 to perform methods or operations according to various embodiments of the present disclosure. For example, a program may include a plurality of instructions executable by the processor 420, and the methods or operations described above may be performed by executing the plurality of instructions by the processor 420. The memory 400 may consist of a single memory or a plurality of memories. In this case, information required to perform the methods or operation according to various embodiments of the present disclosure may be stored in a single memory or distributed across a plurality of memories. When the memory 400 comprises a plurality of memories, the plurality of memories may be physically separated. The memory 400 may include at least one of volatile memory or non-volatile memory. Volatile memory includes Static Random Access Memory (SRAM) or Dynamic Random Access Memory (DRAM), while non-volatile memory includes flash memory.

The processor 420 may include at least one core capable of executing at least one instruction. The processor 420 may execute instructions stored in the memory 400. The processor 420 may comprise a single processor or a plurality of processors.

The storage 440 maintains stored data even if power supplied to the computing device 40 is cut off. For example, the storage 440 may include non-volatile memory or may include a storage medium such as a magnetic tape, an optical disk, or a magnetic disk. A program stored in the storage 440 may be loaded into the memory 400 before being executed by the processor 420. The storage 440 may store files written in a program language, and a program created from the files by a compiler may be loaded into the memory 400. The storage 440 may store data to be processed by the processor 420 and/or data processed by the processor 420.

The input/output interface 460 may provide an interface with an input device such as a keyboard or a mouse and/or an output device such as a display device or a printer. The user may trigger execution of a program by the processor 420 through the input device and/or may check the processing results of the processor 420 through the output device.

The communication interface 480 may provide access to an external network. The computing device 40 may communicate with other devices through the communication interface 480.

Each element of the apparatus or method in accordance with the present disclosure may be implemented in hardware, software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, configured to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present disclosure as being sequentially performed, this is merely a description of the technical idea of one embodiment of the present disclosure. In other words, those having ordinary skill in the art to which one embodiment of the present disclosure belongs may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present embodiments is not limited by the illustrations. Accordingly, one of ordinary skill should understand that the scope of the present disclosure should not be limited by the above explicitly described embodiments but by the claims and equivalents thereof.

What is claimed is:

1. A method performed by a speech recognition system using a hybrid speech recognition engine, the method comprising:
converting, by a cloud automatic speech recognition (ASR) engine, a first speech signal into a first text;
extracting, by a natural language understanding (NLU) engine, an intent and a slot from the first text;
learning, by a local ASR engine, a local database;
converting, by the local ASR engine, a second speech signal corresponding to the slot in the first speech signal into a second text based on a failure of the NLU engine to extract the slot from the first text; and
assigning, by a control module, the second text to the slot.

2. The method according to claim 1, further comprising:
removing, by a preprocessing module, noise from the first speech signal before converting, by the cloud ASR engine, the first speech signal into the first text.

3. The method according to claim 1, further comprising:
determining, by a dialogue manager, an action based on the intent and the slot to which the second text is assigned.

4. The method of claim 3, further comprising:
providing, by a result processing module, a service based on the action.

5. The method according to claim 1, further comprising:
storing, by the local database, a set of data on information optimized for a local environment, the set of data including data of devices.

6. The method according to claim 1, further comprising:
determining the failure of the NLU engine to extract the slot based on a value of the slot being not included in a cloud database learned by the cloud ASR engine.

7. The method according to claim 1, further comprising:
extracting, by the cloud ASR engine and the local ASR engine, a feature vector by applying a feature vector extraction method;
obtaining, by the cloud ASR engine and the local ASR engine, a speech recognition result by comparing the extracted feature vector with a trained reference pattern; and
using, by the cloud ASR engine and the local ASR engine, an acoustic model configured to analyze the extracted feature vector so as to calculate a phoneme probability and/or a language model by composing sentences based on the phoneme probability.

8. The method according to claim 1, further comprising:
digitizing, by the local database, accumulated data based on a usage pattern of a user.

9. A speech recognition system using a hybrid speech recognition engine, the speech recognition system comprising:
a cloud automatic speech recognition (ASR) engine configured to convert a first speech signal into a first text;
a natural language understanding (NLU) engine configured to extract an intent and a slot from the first text;
a local ASR engine configured to learn a local database and convert a second speech signal corresponding to the slot in the first speech signal into a second text based on a failure of the NLU engine to extract the slot from the first text; and
a control module configured to assign the second text to the slot.

10. The speech recognition system according to claim 9, further comprising:
a preprocessing module configured to remove noise from the first speech signal.

11. The speech recognition system according to claim 9, further comprising:
a dialogue manager configured to determine an action based on the intent and the slot to which the second text is assigned.

12. The speech recognition system according to claim 9, further comprising:
a result processing module configured to provide a service based on the action.

13. The speech recognition system according to claim 9, wherein the local database is configured to store a set of data for the local ASR engine to learn and operate based on a local environment or a user demand.

14. The speech recognition system according to claim 9, wherein the failure of the NLU engine to extract the slot is determined based on a value of the slot being not included in a cloud database learned by the cloud ASR engine.

15. The speech recognition system according to claim claim 9, wherein the cloud ASR engine and the local ASR engine are further configured to:
extracting, by the cloud ASR engine and the local ASR engine, a feature vector by applying a feature vector extraction method;
obtain a speech recognition result by comparing the extracted feature vector with a trained reference pattern; and
use an acoustic model configured to analyze the extracted feature vector so as to calculate a phoneme probability and/or a language model by composing sentences based on the phoneme probability.

16. The speech recognition system according to claim 9, wherein local database is further configured to digitize accumulated data based on a usage pattern of a user.
